(19) United States
(12) Patent Application Publication
(10) Pub. No.: US 2026/0300546 A1
(43) Pub. Date: Oct. 1, 2026

(54) PSEUDONYMIZATION DEVICE, PSEUDONYMIZATION METHOD, AND RECORDING MEDIUM

(71) Applicant: NEC Corporation, Tokyo (JP)

(72) Inventors: Junki MORI, Tokyo (JP); Kosuke Kihara, Tokyo (JP); Isamu Teranishi, Tokyo (JP)

(73) Assignee: NEC Corporation, Tokyo (JP)

(21) Appl. No.: 19/574,581

(22) Filed: Mar. 23, 2026

(30) Foreign Application Priority Data
Mar. 27, 2025 (JP) 2025-053495

(51) Int. Cl. G06F 21/62

(52) U.S. Cl. CPC G06F 21/6254

(57) ABSTRACT

In a pseudonymization device, a pseudonymization means pseudonymizes pseudonymization target information of text data. A correction means corrects pseudonymization leak of the text data pseudonymized by the pseudonymization means, based on an instruction of a user.

### INCORPORATION BY REFERENCE

This application is based upon and claims the benefit of priority from Japanese patent application No. 2025-053495, filed on March 27, 2025, the disclosure of which is incorporated herein in its entirety by reference.

### TECHNICAL FIELD

The present disclosure relates to a technique for pseudonymizing information.

### BACKGROUND ART

With progress and spread of artificial intelligence (AI) technology, importance of AI governance is increasing. Security, ethics, and quality are among elements of AI governance. In particular, in a case where AI services provided by other companies are used, it is necessary to prevent privacy leakage by inspecting an input to AI and anonymizing personal information in order to ensure security. For example, Patent Document 1 discloses a method of anonymizing personal information in a text.

Patent Document 1: JP 2023-107143 A

### SUMMARY

In the method of Patent Document 1, the personal information in the text is pseudonymized using an AI model, but the AI model cannot pseudonymize all the personal information in the text. Therefore, in the end, it is necessary for a user to check pseudonymization leak through the entire text, which is troublesome.

An object of the present disclosure is to provide a pseudonymization device that enables easy checking of a portion having a high possibility of pseudonymization leak.

According to an example aspect of the present invention, there is provided a pseudonymization device, including:
at least one memory configured to store instructions; and
at least one processor configured to execute the instructions to:
pseudonymize pseudonymization target information of text data; and
correct pseudonymization leak of the pseudonymized text data, based on an instruction of a user.

According to another example aspect of the present invention, there is provided a pseudonymization method including:
pseudonymizing pseudonymization target information of text data; and
correcting pseudonymization leak of the pseudonymized text data, based on an instruction of a user.

According to a further example aspect of the present invention, there is provided a recording medium recording a program for causing a computer to execute processing including:
pseudonymizing pseudonymization target information of text data; and
correcting pseudonymization leak of the pseudonymized text data, based on an instruction of a user.

According to the present disclosure, it is possible to easily check a portion having a high possibility of pseudonymization leak.

### BRIEF DESCRIPTION OF THE DRAWINGS

FIG. 1 illustrates an overall configuration of a pseudonymization and re-identification system to which a pseudonymization device according to the present disclosure is applied;

FIG. 2 is a block diagram illustrating a hardware configuration of the pseudonymization device according to the present disclosure;

FIG. 3 is a block diagram illustrating a functional configuration of the pseudonymization device according to the present disclosure;

FIGS. 4A and 4B are each a diagram for describing processing by a pseudonymization unit;

FIG. 5 is an example of display data by a phrase emphasizing unit;

FIG. 6 is an example of display data by a topic estimation unit;

FIG. 7 is a flowchart of processing by the pseudonymization device according to the present disclosure;

FIG. 8 is a block diagram illustrating a functional configuration of another pseudonymization device according to the present disclosure; and

FIG. 9 is a flowchart of processing by the another pseudonymization device according to the present disclosure.

### EXAMPLE EMBODIMENT

Hereinafter, preferred example embodiments of the present disclosure will be described with reference to the drawings.

### First example embodiment

### Overall configuration

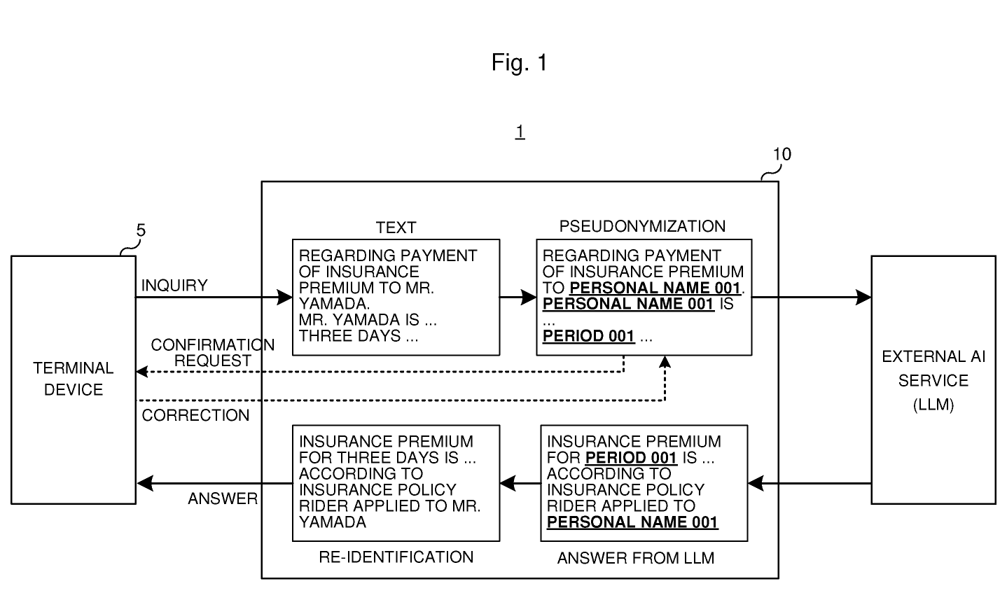

FIG. 1 illustrates an overall configuration of a pseudonymization and re-identification system to which a pseudonymization device according to the present disclosure is applied. The pseudonymization and re-identification system 1 includes a terminal device 5, the pseudonymization device 10, and an external AI service. The terminal device 5 and the pseudonymization device 10 can communicate with each other in a wired or wireless manner.

In the present example embodiment, a service of a language model such as large language models (LLM) is used as the external AI service. A specific language model is, for example, ChatGPT by OpenAI, or the like. Hereinafter, the language model is also referred to as “LLM”.

The terminal device 5 is operated by a user who uses the LLM, or the like, and transmits a sentence or a text (hereinafter, also referred to as “text data”) input by the user to the pseudonymization device 10. The terminal device 5 includes, for example, a personal computer.

The pseudonymization device 10 pseudonymizes personal information or the like in the text data and transmits the pseudonymized text data to the external LLM. In a case where receiving an answer from the external LLM, the pseudonymization device 10 re-identifies a pseudonymized portion in the answer to the original personal information or the like, and transmits the re-identified answer to the terminal device 5. The pseudonymization device 10 includes, for example, a server device or the like, and communicates with the LLM through a network such as the Internet.

The pseudonymization device 10 of the present example embodiment transmits the pseudonymized text data to the terminal device 5 before transmitting the pseudonymized text data to the external LLM, and requests the user for confirmation. At this time, the pseudonymization device 10 emphasizes a portion that is not pseudonymized in the text data and may correspond to personal information or the like (hereinafter, also referred to as “pseudonymization leak”), and then transmits the pseudonymized text data to the terminal device 5. As a result, the user can easily check the portion having a high possibility of pseudonymization leak.

Here, the personal information or the like includes information that should not be leaked to the outside, such as personal information, privacy information, and confidential information. The personal information or the like is an example of “pseudonymization target information”. Examples of the personal information include personally identifiable information (PII), which is information by which an individual can be identified. The personal information includes a direct identifier, such as a full name, a mobile number, a residence address, a mail address, an individual number, and a bank account of an individual, and an indirect identifier, such as a demographic feature (gender, age, height, weight, race, ethnic group, or the like), a place of employment, a date such as a date of birth, and an acquaintance of the individual. The privacy information indicates information desired to be kept secret of an individual, and information that may interfere with a private life when disclosed. The confidential information indicates information that is not scheduled to be disclosed to the outside among information held by a company and that may cause damage to the company due to the disclosure. The confidential information includes, for example, a customer name, a product name under development, a budget, a sales amount, and the like.

The language model is a model that outputs an answer to an input language as a language. The input language and the output language do not necessarily have to match. The language model may be, for example, a model that outputs an answer in a format different from a language, such as an image or a voice.

### Hardware configuration

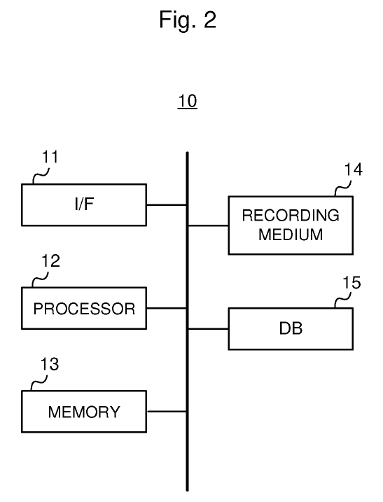

FIG. 2 is a block diagram illustrating a hardware configuration of the pseudonymization device 10 according to the first example embodiment. As illustrated, the pseudonymization device 10 includes an interface (I/F) 11, a processor 12, a memory 13, a recording medium 14, and a database (DB) 15.

The I/F 11 communicates with the terminal device 5 and the external LLM through a network such as the Internet.

The processor 12 is a computer such as a central processing unit (CPU), and takes overall control of the pseudonymization device 10 by executing a program prepared in advance. The processor 12 may be a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The processor 12 executes pseudonymization processing to be described later.

The memory 13 includes a read only memory (ROM), a random access memory (RAM), and the like. The memory 13 is also used as a work memory during execution of various types of processing performed by the processor 12.

The recording medium 14 is a non-volatile non-transitory recording medium such as a disk-shaped recording medium or a semiconductor memory, and is attachable to and detachable from the pseudonymization device 10. The recording medium 14 records various programs to be executed by the processor 12. In a case where the pseudonymization device 10 executes various types of processing, a program recorded in the recording medium 14 is loaded into the memory 13 and executed by the processor 12.

The DB 15 stores, for example, data indicating a correspondence between a named entity and a replaced pseudonymized tag, a rule for topic estimation, and the like.

In addition to the above, the pseudonymization device 10 may include a display device such as a liquid crystal display, and an input device such as a keyboard or a mouse. The display device and the input device are used by an administrator of the pseudonymization device 10 to perform required administration, for example.

### Functional configuration

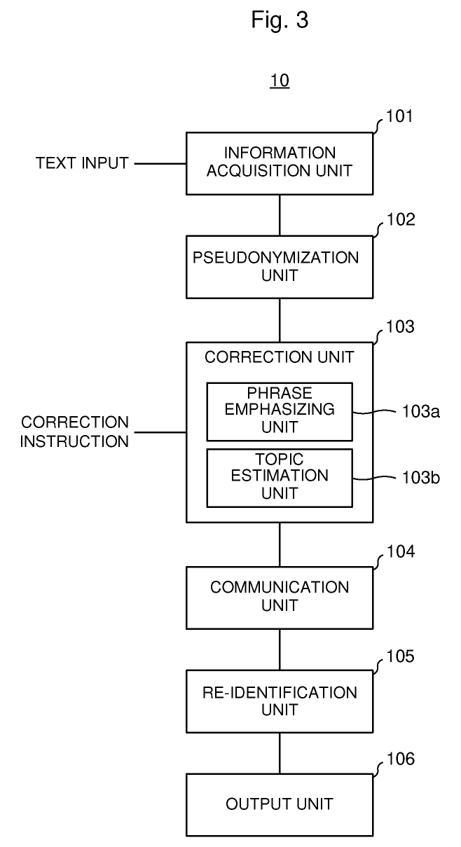

FIG. 3 is a block diagram illustrating a functional configuration of the pseudonymization device 10 of the first example embodiment. The pseudonymization device 10 functionally includes an information acquisition unit 101, a pseudonymization unit 102, a correction unit 103, a communication unit 104, a re-identification unit 105, and an output unit 106. The information acquisition unit 101, the pseudonymization unit 102, the correction unit 103, the communication unit 104, the re-identification unit 105, and the output unit 106 are included in the processor 12 illustrated in FIG. 2.

The pseudonymization device 10 receives text data from the terminal device 5 through the I/F 11. The text data is input to the information acquisition unit 101. The information acquisition unit 101 outputs the text data to the pseudonymization unit 102.

The pseudonymization unit 102 pseudonymizes personal information or the like included in the text data, and generates pseudonymized text data.

First, the pseudonymization unit 102 extracts named entities (for example, proper names, dates and times, quantities, and the like) included in the text data, and classifies the extracted named entities into predefined classes, using a named entity extraction model. The predefined classes include a plurality of classes indicating personal information or the like (for example, a personal name, an organization name, a region, a date, and the like), and a class not indicating personal information or the like (for example, not personal information or the like). The named entity extraction model calculates a probability that the extracted named entity belongs to each class, and sets the class having the highest probability as the class to which the named entity belongs.

The named entity extraction model is created, for example, by causing a transformer model such as bidirectional encoder representations from transformers (BERT) or robustly optimized BERT approach (RoBERTa) to learn by fine-tuning or the like, using a learning data set in which a label such as “personal name”, “organization name”, “region”, “date”, or “not personal information or the like” is given to a named entity in text data. The named entity extraction model is not limited to the above, and may be any AI model that uses text data as an input and classifies a named entity in the text data into a predefined class.

Next, the pseudonymization unit 102 replaces the named entity classified into the class indicating personal information or the like with a temporary value (hereinafter, also referred to as a “pseudonymized tag”). The pseudonymized tag is determined in accordance with a predetermined naming rule (composition rule). In the present example embodiment, a composition of “class name + number (three-digit display format)” is used as the naming rule of the pseudonymized tag. The number mentioned above is assigned in such a way that personal information or the like having the same class can be uniquely identified.

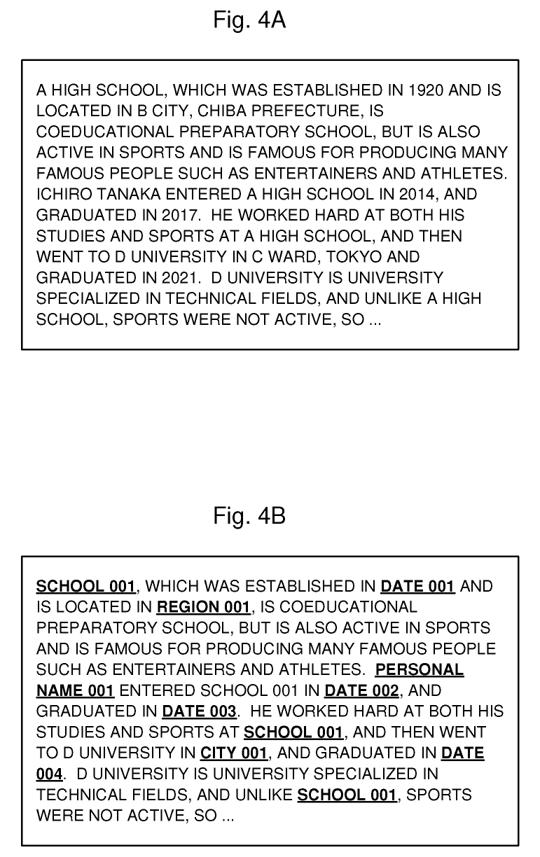

FIGS. 4A and 4B are each a diagram for describing processing by the pseudonymization unit 102. The pseudonymization unit 102 extracts named entities from text data illustrated in FIG. 4A and classifies the named entities into predefined classes. In FIG. 4A, the pseudonymization unit 102 classifies named entities such as “A high school”, “1920”, “B city in Chiba prefecture”, “Ichiro Tanaka”, and the like into “school”, “date”, “region”, “personal name”, and the like, which are classes indicating personal information or the like. Then, the pseudonymization unit 102 replaces the named entity classified into the class indicating personal information or the like with the pseudonymized tag, and generates pseudonymized text data as illustrated in FIG. 4B.

The pseudonymization unit 102 generates data indicating a correspondence between the named entity and the replaced pseudonymized tag, and outputs the data to the DB 15. The pseudonymization unit 102 outputs a result of class classification by the named entity extraction model and the pseudonymized text data to the correction unit 103.

The correction unit 103 transmits the pseudonymized text data to the terminal device 5, and receives a correction instruction of the user from the terminal device 5.

The correction unit 103 includes a phrase emphasizing unit 103a and a topic estimation unit 103b. The correction unit 103 emphasizes a portion having a possibility of pseudonymization leak in the pseudonymized text data by processing of either one or both of the phrase emphasizing unit 103a and the topic estimation unit 103b, and transmits the pseudonymized text data to the terminal device 5. The processing by the phrase emphasizing unit 103a and the topic estimation unit 103b will be described below. A phrase indicates a group of words including one or more words.

### Phrase emphasizing unit

The phrase emphasizing unit 103a detects a portion having a possibility of pseudonymization leak from the pseudonymized text data, based on the result of class classification, and emphasizes the detected portion. Examples of emphasizing methods include emphasizing by highlight, emphasizing by bold or underline, and emphasizing by changing character color.

The phrase emphasizing unit 103a sets a named entity that is classified into the “not personal information or the like” class and has a probability of belonging to other classes other than the “not personal information or the like” class equal to or more than a predetermined threshold value TH1, as a portion having a possibility of pseudonymization leak. Specifically, the phrase emphasizing unit 103a can determine whether there is a possibility of pseudonymization leak by comparing a second highest probability among probabilities belonging to each class with the predetermined threshold value TH1. For example, in FIG. 4B, “D University” that is a named entity is classified into the “not personal information or the like” class, and is not replaced with a pseudonymized tag. Here, it is assumed that a result of class classification of “D University” by the named entity extraction model is “50% probability of not being personal information or the like, 45% probability of being school, 2% probability of being personal name,...”, and the predetermined threshold value TH1 is 40%. Since the probability of the second highest class (school) is equal to or more than the predetermined threshold value, the phrase emphasizing unit 103a determines that “D University” has a possibility of pseudonymization leak.

The method for determining whether there is a possibility of pseudonymization leak is not limited to the above. For example, the phrase emphasizing unit 103a may determine, for a named entity classified into the “not personal information or the like” class, whether there is a possibility of pseudonymization leak, based on a difference between a probability of belonging to the “not personal information or the like” class and a second highest probability. In a case where the difference is equal to or less than a predetermined threshold value TH2 (that is, in a case where the difference is small), the phrase emphasizing unit 103a determines that the named entity has a possibility of pseudonymization leak.

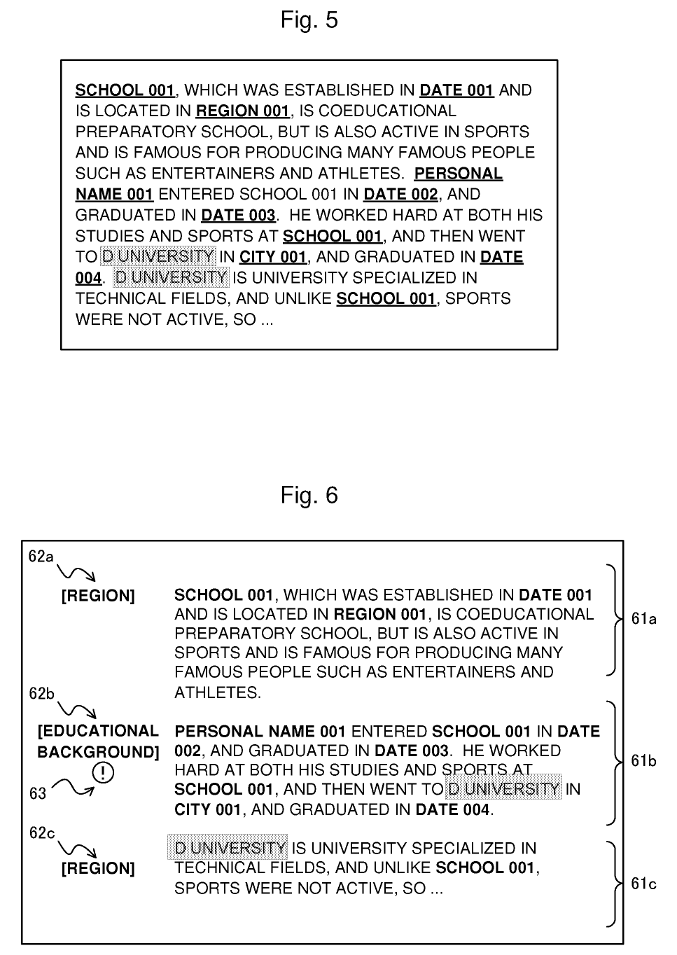

Then, the phrase emphasizing unit 103a emphasizes the named entity determined to have a possibility of pseudonymization leak. For example, the phrase emphasizing unit 103a emphasizes “D University” in FIG. 4B by highlighting to create display data as illustrated in FIG. 5. Hereinafter, display data created by the phrase emphasizing unit 103a is also referred to as “pseudonymized text data subjected to first processing”.

The phrase emphasizing unit 103a transmits the pseudonymized text data subjected to the first processing to the terminal device 5. In a case where the processing of both the phrase emphasizing unit 103a and the topic estimation unit 103b is performed on one piece of pseudonymized text data, the phrase emphasizing unit 103a outputs the pseudonymized text data subjected to the first processing to the topic estimation unit 103b. Then, the topic estimation unit 103b executes the processing to be described later on the pseudonymized text data subjected to the first processing, instead of the pseudonymized text data.

### Topic estimation unit

The topic estimation unit 103b divides the pseudonymized text data for each topic and emphasizes a topic related to personal information or the like. Examples of emphasizing methods include emphasizing by bold or underline, emphasizing by changing character color, and emphasizing by giving a mark.

The topic estimation unit 103b divides the pseudonymized text data for each sentence and converts each sentence into a vector. The topic estimation unit 103b calculates similarity between a sentence and preceding and following sentences (adjacent sentences) thereof, and groups the sentences having the similarity equal to or more than a predetermined threshold value TH3 as a chunk. The topic estimation unit 103b can convert a sentence into a vector using a model such as BERT or Sentence-BERT, for example. The topic estimation unit 103b can use, for example, cosine similarity or Euclidean distance as the similarity.

The chunking method is not limited to the above. For example, as described in the following document, the topic estimation unit 103b may estimate a break of a topic from transition of appearance frequency of a word and divide text data into chunks. The topic estimation unit 103b may divide text data into chunks using transition of a degree of relevance between sentences calculated by a model such as BERT, instead of transition of appearance frequency of a word.
M.A.Hearst, “TextTiling: Segmenting Text into Multi paragraph Subtopic Passages,” Computational Linguistics, Vol. 23, No. 1, pp. 33-64, 1997.

Next, the topic estimation unit 103b estimates a topic of each chunk by the following method (1) or (2).
(1) Topic estimation based on rules
The topic estimation unit 103b estimates a topic of a chunk by comparing a phrase included in the chunk with predetermined rules. Examples of the rules include a rule in which a phrase and a topic related to the phrase are associated with each other, and a rule in which a combination of phrases and a topic related to the combination of phrases are associated with each other. These rules are stored in the DB 15, for example. Examples of the rules will be described below.
(Example 1) In a case where “fund management” appears in a chunk, a topic is “management”.
(Example 2) In a case where “company” and “joined” appear in a chunk, a topic is “work history”.
(Example 3) In a case where “university” and “graduated from” appear once in a chunk, a topic is “educational background”.

In a case where one chunk corresponds to a plurality of rules, the topic estimation unit 103b may give a plurality of topics to one chunk.

(2) Topic estimation by AI model
The topic estimation unit 103b estimates a topic of a chunk using an AI model. This AI model is an AI model that classifies input chunks into a plurality of predefined topics. This AI model is created, for example, by fine-tuning a model such as BERT using a learning data set in which chunks and topics are associated with each other. The AI model is not limited to the above, and may be any AI model that classifies input chunks into a plurality of predefined topics.

Next, the topic estimation unit 103b divides the pseudonymized text data for each chunk, and generates display data including a topic relevant to each chunk. At this time, the topic estimation unit 103b generates the display data by emphasizing a topic related to personal information or the like. The topics related to personal information or the like include, for example, “educational background”, “work history”, “financial information”, “personnel information”, and the like. It is assumed that the topics related to personal information or the like are determined in advance. FIG. 6 is an example of display data by the topic estimation unit 103b. FIG. 6 includes chunks 61a to 61c, and topics 62a to 62c relevant to the chunks. In FIG. 6, the topic 62b (educational background) section related to personal information or the like is emphasized with a mark 63 and an underline. Hereinafter, data created by the topic estimation unit 103b is also referred to as “pseudonymized text data subjected to second processing”.

The topic estimation unit 103b transmits the pseudonymized text data subjected to the second processing to the terminal device 5.

The user operates the terminal device 5, refers to the pseudonymized text data subjected to the first processing or the pseudonymized text data subjected to the second processing, and instructs correction of a pseudonymization leak portion. The correction instruction includes an instruction to replace the pseudonymization leak portion with a pseudonymized tag. The correction unit 103 corrects the pseudonymized text data based on the correction instruction, and outputs the corrected pseudonymized text data to the communication unit 104.

With the display of the pseudonymized text data subjected to the first processing, the user can efficiently check a named entity having a high possibility of pseudonymization leak. With the display of the pseudonymized text data subjected to the second processing, the user can efficiently check whether a text that is not expressed by a single word or idiom, or a chunk including a plurality of texts corresponds to privacy information or confidential information.

The communication unit 104 transmits the corrected pseudonymized text data input from the correction unit 103 to the external LLM and receives an answer from the external LLM, through the I/F 11. The communication unit 104 outputs the LLM answer to the re-identification unit 105.

The re-identification unit 105 returns a pseudonymized tag included in the LLM answer to the original personal information or the like. The re-identification unit 105 refers to the data indicating the correspondence between the named entity and the replaced pseudonymized tag stored in the DB 15, and can return the pseudonymized tag in the LLM answer to the original personal information or the like. The re-identification unit 105 outputs the re-identified LLM answer to the output unit 106. The output unit 106 transmits the re-identified LLM answer to the terminal device 5.

In the above configuration, the information acquisition unit 101 and the pseudonymization unit 102 are an example of pseudonymization means, the correction unit 103 is an example of correction means, the communication unit 104 is an example of transmitting means and receiving means, the re-identification unit 105 is an example of re-identification means, and the output unit 106 is an example of output means.

### Processing flow

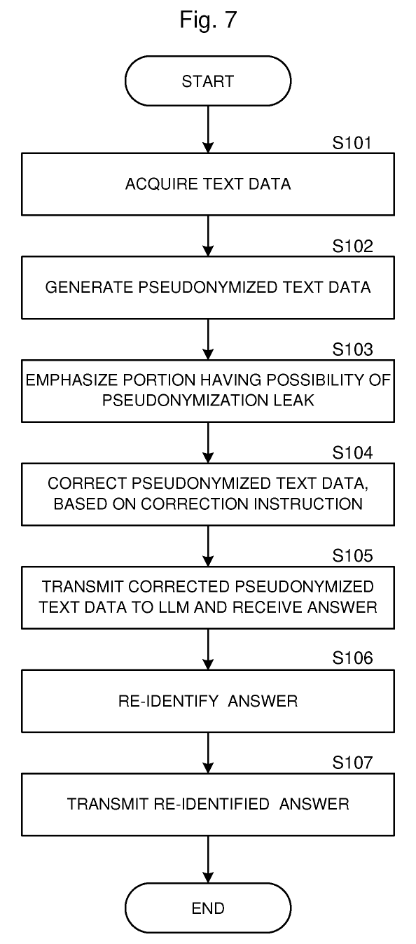

Next, pseudonymization processing by the pseudonymization device 10 will be described. FIG. 7 is a flowchart of the pseudonymization processing by the pseudonymization device 10. This processing is achieved by the processor 12 illustrated in FIG. 2 executing a program prepared in advance and operating as each element illustrated in FIG. 3.

The pseudonymization device 10 receives text data from the terminal device 5 through the I/F 11. The text data is input to the information acquisition unit 101 (step S101). The information acquisition unit 101 outputs the text data to the pseudonymization unit 102.

Next, the pseudonymization unit 102 pseudonymizes personal information or the like included in the text data, and generates pseudonymized text data (step S102). The pseudonymization unit 102 outputs the pseudonymized text data to the correction unit 103.

Next, the correction unit 103 emphasizes a portion having a possibility of pseudonymization leak in the pseudonymized text data, and transmits the pseudonymized text data to the terminal device 5 (step S103). Then, the correction unit 103 receives a correction instruction of the user from the terminal device 5, and corrects the pseudonymized text data based on the correction instruction (step S104). The correction unit 103 outputs the corrected pseudonymized text data to the communication unit 104.

Next, the communication unit 104 transmits the corrected pseudonymized text data to the external LLM and receives an answer from the external LLM, through the I/F 11 (step S105). The communication unit 104 outputs the LLM answer to the re-identification unit 105.

Next, the re-identification unit 105 re-identifies the LLM answer (step S106). Specifically, the re-identification unit 105 returns a pseudonymized tag included in the LLM answer to the original personal information or the like. The re-identification unit 105 outputs the re-identified LLM answer to the output unit 106. The output unit 106 transmits the re-identified LLM answer to the terminal device 5 (step S107). The processing then ends.

### Modification

Next, a modification of the first example embodiment will be described.

In the above example embodiment, first, the pseudonymization unit 102 generates pseudonymized text data, and then the topic estimation unit 103b divides the pseudonymized text data for each topic. Instead, the topic estimation unit 103b may first divide text data before pseudonymization for each topic, and then the pseudonymization unit 102 may perform pseudonymization processing on the text data divided for each topic.

### Second example embodiment

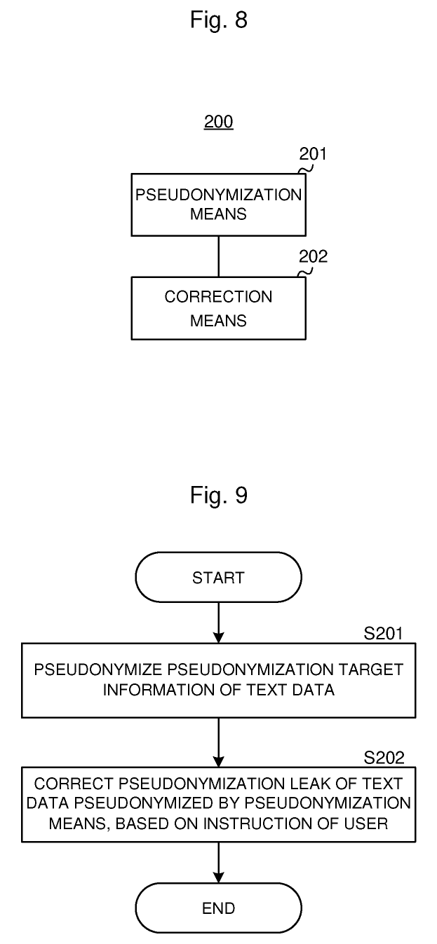

FIG. 8 is a block diagram illustrating a functional configuration of a pseudonymization device of a second example embodiment. The pseudonymization device 200 includes pseudonymization means 201 and correction means 202.

FIG. 9 is a flowchart of processing by the pseudonymization device of the second example embodiment. The pseudonymization means 201 pseudonymizes pseudonymization target information of text data (step S201). The correction means 202 corrects pseudonymization leak of the text data pseudonymized by the pseudonymization means, based on an instruction of a user (step S202).

The pseudonymization means 201 can be achieved using the information acquisition unit 101 and the pseudonymization unit 102 according to the first example embodiment. The correction means 202 can be achieved using the correction unit 103 according to the first example embodiment.

According to the pseudonymization device 200 of the second example embodiment, it is possible to easily check a portion having a high possibility of pseudonymization leak.

Some or all of the above example embodiments can also be described as the following supplementary notes, but are not limited to the following.

### Supplementary Note 1

A pseudonymization device including:
pseudonymization means for pseudonymizing pseudonymization target information of text data; and
correction means for correcting pseudonymization leak of the text data pseudonymized by the pseudonymization means, based on an instruction of a user.

### Supplementary Note 2

The pseudonymization device according to Supplementary Note 1, further including
phrase emphasizing means for emphasizing a portion having a possibility of pseudonymization leak, in which
the correction means transmits the text data pseudonymized by the pseudonymization means and emphasized by the phrase emphasizing means to a terminal device, and receives the instruction of the user from the terminal device.

### Supplementary Note 3

The pseudonymization device according to Supplementary Note 2, in which
the pseudonymization means extracts named entities from the text data, and classifies the named entities into a class indicating pseudonymization target information and a class not indicating pseudonymization target information, using a named entity extraction model, and
the phrase emphasizing means emphasizes a named entity whose probability of belonging to the class indicating pseudonymization target information is equal to or more than a predetermined threshold value, among named entities classified into the class not indicating pseudonymization target information.

### Supplementary Note 4

The pseudonymization device according to Supplementary Note 1 or 2, further including
topic emphasizing means for dividing the text data pseudonymized by the pseudonymization means for each topic and emphasizing a topic related to the pseudonymization target information, in which
the correction means transmits the text data pseudonymized by the pseudonymization means and emphasized by the topic emphasizing means to a terminal device, and receives the instruction of the user from the terminal device.

### Supplementary Note 5

The pseudonymization device according to Supplementary Note 4, in which the topic emphasizing means divides the text data pseudonymized by the pseudonymization means for each sentence, groups semantically related preceding and following sentences as a chunk, and estimates a topic from the chunk.

### Supplementary Note 6

The pseudonymization device according to Supplementary Note 5, in which
the topic emphasizing means estimates a topic from a phrase included in the chunk, based on a predetermined rule, and
the predetermined rule is a rule in which a combination of phrases and a topic related to the combination of phrases are associated with each other.

### Supplementary Note 7

The pseudonymization device according to Supplementary Note 6, in which
the topic emphasizing means estimates a topic from the chunk using an AI model, and
the AI model is an AI model that classifies input chunks into a plurality of predefined topics.

### Supplementary Note 8

The pseudonymization device according to any one of Supplementary Notes 1 to 7, further including:
transmitting means for transmitting the text data pseudonymized by the pseudonymization means and corrected by the correction means to an external language model;
receiving means for receiving an answer from the external language model; and
re-identification means for re-identifying a pseudonymized portion in the answer to original pseudonymization target information.

### Supplementary Note 9

A pseudonymization method executed by a computer, including:
pseudonymizing pseudonymization target information of text data; and
correcting pseudonymization leak of the pseudonymized text data, based on an instruction of a user.

### Supplementary Note 10

A program for causing a computer to execute processing of:
pseudonymizing pseudonymization target information of text data; and
correcting pseudonymization leak of the pseudonymized text data, based on an instruction of a user.

### Supplementary Note 11

The pseudonymization device according to Supplementary Note 3, further including
learning means for executing learning of the named entity extraction model using learning data in which a correct class is labeled with respect to a named entity in text data, in which
the class includes a class indicating pseudonymization target information and a class not indicating pseudonymization target information.

### Supplementary Note 12

The pseudonymization device according to Supplementary Note 11, in which the class indicating pseudonymization target information includes at least one of a personal name, an organization name, a region, and a date.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

5 terminal device
10 pseudonymization device
101 information acquisition unit
102 pseudonymization unit
103 correction unit
104 communication unit
105 re-identification unit
106 output unit

1. A pseudonymization device comprising:
at least one memory configured to store instructions; and
at least one processor configured to execute the instructions to:
pseudonymize pseudonymization target information of text data; and
correct pseudonymization leak of the pseudonymized text data, based on an instruction of a user.

2. The pseudonymization device according to claim 1, the one or more processors are further configured to emphasize a portion having a possibility of pseudonymization leak, wherein
the one or more processors transmit the pseudonymized and emphasized text data to a terminal device, and receive the instruction of the user from the terminal device.

3. The pseudonymization device according to claim 2, wherein
the one or more processors extract named entities from the text data, and classify the named entities into a class indicating pseudonymization target information and a class not indicating pseudonymization target information, using a named entity extraction model, and
the one or more processors emphasize a named entity whose probability of belonging to the class indicating pseudonymization target information is equal to or more than a predetermined threshold value, among named entities classified into the class not indicating pseudonymization target information.

4. The pseudonymization device according to claim 1, the one or more processors are further configured to divide the pseudonymized text data for each topic and emphasize a topic related to the pseudonymization target information, wherein
the one or more processors transmit the pseudonymized and emphasized text data to a terminal device, and receive the instruction of the user from the terminal device.

5. The pseudonymization device according to claim 4, wherein the one or more processors divide the pseudonymized text data for each sentence, group semantically related preceding and following sentences as a chunk, and estimate a topic from the chunk.

6. The pseudonymization device according to claim 5, wherein
the one or more processors estimate a topic from a phrase included in the chunk, based on a predetermined rule, and
the predetermined rule is a rule in which a combination of phrases and a topic related to the combination of phrases are associated with each other.

7. The pseudonymization device according to claim 6, wherein
the one or more processors estimate a topic from the chunk using an AI model, and
the AI model is an AI model that classifies input chunks into a plurality of predefined topics.

8. The pseudonymization device according to claim 1, the one or more processors are further configured to transmit the pseudonymized and corrected text data to an external language model;
receive an answer from the external language model; and
re-identify a pseudonymized portion in the answer to original pseudonymization target information.

9. The pseudonymization device according to claim 3, the one or more processors are further configured to execute learning of the named entity extraction model using learning data in which a correct class is labeled with respect to a named entity in text data, in which
the class includes a class indicating pseudonymization target information and a class not indicating pseudonymization target information.

10. The pseudonymization device according to claim 9, in which the class indicating pseudonymization target information includes at least one of a personal name, an organization name, a region, and a date.

11. A pseudonymization method executed by a computer, comprising:
pseudonymizing pseudonymization target information of text data; and
correcting pseudonymization leak of the pseudonymized text data, based on an instruction of a user.

12. A non-transitory computer readable recording medium recording a program for causing a computer to execute processing comprising:
pseudonymizing pseudonymization target information of text data; and
correcting pseudonymization leak of the pseudonymized text data, based on an instruction of a user.
